(19) United States
(12) Patent Application Publication
(10) Pub. No.: US 2009/0029322 A1
(43) Pub. Date: Jan. 29, 2009

(54) Use of Stem Cells, Method of Tissue Engineering, Use of Dental Tissues and Tooth Biological Substitute

(75) Inventors: Silvio Eduardo Duailibi, Sao Paulo (BR); Monica Talarico Duailibi, Sao Paulo (BR); Pamela C. Yelick, Boston, MA (US); Joseph P. Vacanti, Boston, MA (US)

Correspondence Address: BANNER & WITCOFF, LTD., 1100 13th STREET, N.W., SUITE 1200, WASHINGTON, DC, 20005-4051, US

(73) Assignee: Massachusetts General Hospital, Boston, MA (US)

(21) Appl. No.: 11/630,476

(22) PCT Filed: Jun. 23, 2005
(86) PCT No.: PCT/BR05/00121

§ 371 Date: Jun. 30, 2008

(30) Foreign Application Priority Data
Jun. 23, 2004 (BR) PI 0402659-4

(51) Int. Cl. A61C 13/00; A61C 13/08

(52) U.S. Cl. 433/215; 433/212.1

(57) ABSTRACT

The present invention is related to the use of stem cells of an animal species for obtainment of biological tooth substitute, in whole or in parts, to be implanted in organism of the same animal strain, wherein said stem cells can be adult cells. The present invention still aims to develop a method of tissue engineering for culturing cells capable to form dental tissue for production of a tooth biological substitute. The said dental tissue can used for the treatment of people suffering from loss, fail or lack of these tissues, and also for cosmetic use of those tissues for a morphological modifying on a patient dentition, for example, the patient may desire to, or need to, have a bigger or smaller dentition for any aesthetic reason.

### FIELD OF THE INVENTION

The present invention is related to the use of animal species stem cells for obtainment of a tooth biological substitute, in whole or in part, to be implanted in an organism of the same strain. Said cells can be adult cells.

The present invention is also related to a method of tissue engineering for culture of cells for dental tissue formation for obtainment of a tooth biological substitute and the obtained biological substitute.

The present invention is also related to the use dental tissues for treatment of subjects which suffered loss, fails or lacks of those said tissues and to the cosmetic use of dental tissue.

It is still an object of the present invention method for culturing material from stem cells.

### BACKGROUND OF THE INVENTION

It is known by dental regeneration state of art, either partial or total, that synthetic material in fact promotes a dental element functional repairing but not anatomical and functional structure regeneration. Such methods comprise the metallic implantations field, mainly bone integrated dental implantations, developed by many companies from odontological implantation field. Despite of technical developments such said transplants cause many problems for the transplanted patient.

This industrial sector growth indicates that teeth substitution, due to several causes, is needed.

Tissue engineering or the technique for production of substitute human parts from biological construction is an innovative field of biological regeneration which promises great improvements in medical field, leading to the integration of many medicine specialties such as physiology, molecular and cellular biology, and engineering.

The basic principle of tissue engineering is tissue production through cells culture developed in laboratory, and bonded to pores of some synthetic scaffold made of body-absorptive synthetic matrix. Recent studies have shown that several types of cells can proliferate and maintain its phenotypical characteristics, when cultivated in bidimensional substrates or inside three-dimensional matrices pores in vitro. Basically, this is the best way for getting tissue regeneration in vivo.

Further to biological substances handling problems, the guarantee for keeping cell phenotyping is the biggest concern of technicians due to difficulties to solve both cells phenotypical characteristics and the necessary amount of cells.

There are some researches that aim a biological tooth substitute from stem cells. The international application PCT/GB01/00651 discloses the use of neural or embryo stem cells and oral epithelium cells cultivated for producing the progenitor tooth cell. Further studies had been carried on rats with pig stem cells. Regarding characterization of tooth tissue in immune suppressed rat's abdomen, Young et al. (Young C S, Terada S, Vacanti J P, Honda M, Barlett J D, Yelick P C (2002). “Tissue engineering of complex tooth structure on biodegradable polymer scaffolds”. J. Dent. Res., 81: 695-700) had used cells dissociated from pig third molar, kept cultivated in rich medium and then impregnated over a biodegradable polyglycolic acid (PGA) scaffold. The assembly of scaffold and cells were implanted in omentum of without thymus Rowett rat, being removed 30 weeks after the implantation. Tissues were kept in ice. Authors had identified dental tissue through immune histochemical analysis. This study had proved the possibility of dental tissue development through Tissue Engineering techniques.

In the same way it can be cited the international issues WO 03/101503 and WO 03/101502 as a result of Honda et al. work group which looks for the development of a method for culturing cells by means of mechanical stimulation on a polymeric base.

That research shows a great potential in tissue engineering field, however it may presents some non-compatibility disadvantages since the stem cells employed are not from the same organism, or the same species of the animal to be treated.

The inventors of present invention had looked for to develop tissue dental from adult stem cells, not only from embryo, or from animals of same species.

### BRIEF DESCRIPTION OF THE DRAWINGS

FIG. 1 shows a silicone material molding of a tooth pattern, with a predefined form.

FIG. 2 shows the scaffold obtainment in polymeric material previously assembled in laboratory to create a porosity higher than 95%, which means pores of about 250˜500 μm sheltering the cellular components.

FIG. 3 is a microscopic photo of the polymeric matrix associated to the cellular component. The picture A and B show a PGA scaffold impregnated with tooth seed cells with respectively 1 and 12 hours of waiting for cellular adhesion. Pictures C and D show the same for a PLGA scaffold.

FIG. 4A shows the macroscopic aspect and FIG. 4B shows X-ray aspect of the PGA scaffold after 12 weeks, previous removal of the material implanted in omentum.

FIG. 5A shows the macrocospic aspect and FIG. 5B shows X-ray aspect of the PLGA scaffold after 12 weeks, previous removal of the material implanted in omentum.

FIG. 6 shows the histological aspect of tissue sections and stained by Goldner's trichrome method. Picture A and B show the control group C1 in 5× and 20× magnifying respectively. Picture C and D show the PGA scaffold implantation group IV in 5× and 20× magnifying respectively. The same in Pictures E and F. Picture G and H show the PLGA scaffold implantation group IV in 40× magnifying.

FIG. 7 shows the histological aspect of tissue sections and stained by H/E method. Picture A and B show the control group C1 in 5× and 20× magnifying respectively. Picture C and D show the PGA scaffold implantation group IV in 5× and 20× magnifying respectively. The same is showed in Pictures E and F. Picture G and H show the PLGA scaffold implantation group IV both in 40× magnifying.

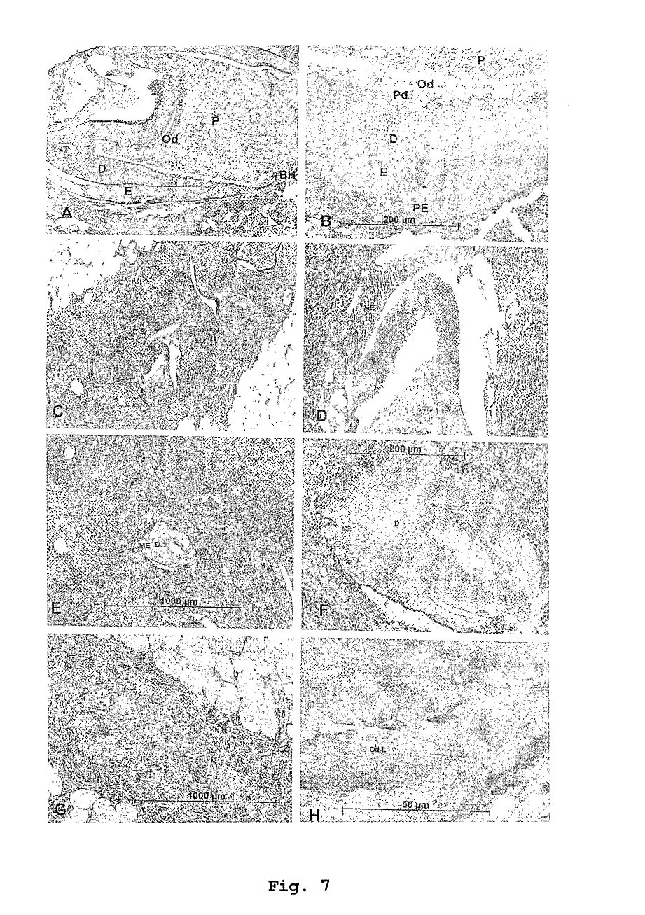

FIG. 8 shows the result of the immunohistochemical analysis of the amelogenin expression. Picture A shows C1 group amelogenin expression. Picture B illustrates the negative control with a preimmune reaction. Picture C shows the dental enamel presence on PGA implantation impregnated with tooth cells. In picture A and C brownish color indicates the enamel presence.

### DESCRIPTION OF THE INVENTION

The present invention is related to the use of stem cells of animal species for obtainment of biological tooth substitute, in whole or in parts, to be implanted in organism of the same animal strain.

Said stem cells can be embryo or adult cells. According to a particular embodiment of the present invention the tooth tissue used is extracted from adult cells, more specifically the tooth tissue extracted from tooth bud cells.

The present invention still aims a method of tissue engineering for culturing cells which are capable to form dental tissue for obtainment of biological tooth substitute comprising:

a) obtaining cells capable to form dental tissue from stem cells;

b) culturing cells from (a), wherein the cells are initially cultivated in the absence of bovine serum and/or bovine fetal serum;

c) seeding cultivated cells in a biodegradable material scaffold; and

d) implanting the scaffold assembly into organism of the same animal strain which cells are capable to form dental tissue, from which the original dental cells came from.

According to particular embodiment of the present invention the stem cells are embryo or adult cells, more particularly are adult cells, still more particularly adult cells extracted from tooth embryo cells on buds stage. In the case of implantations in rats, animal utilization from 3 to 7 after-birth days (abd), more particularly 4 abd, will result in more adequate cellular cultivation in order to keep a stable cell phenotype memory.

Firstly tooth embryo is histologically observed in dental lamina depression, on the basal layer of the proliferative oral ectoderm. This is the epithelial ridge band which invades the horseshoe-shaped adjacent ectomesenchyme, a tooth bud precursor, which will form tooth enamel. This phase characterizes the button stage with low polygonal cylindrical cells.

According to a particular embodiment of the present invention stem cells are took from tooth buds on button stage.

After said button stage, mitosis cell division results on a tissue condensation just under enamel structure, originating tooth's pulp (conjunctive tissue). This enamel and pulp surrounding cell condensation will form dentine and final pulp. Follicle tooth cells will originate tooth cementum and the periodontal ligament. The differential growth of dental embryo leads to the cap-shaped stage, characterized by a light invagination on the deepest embryo surface. This stage also forms the stellate reticulum cells which are fluid filled cells with protective cushioning function of the enamel organ. This process is followed by the bell stage which allows a better identification of the four cellular structures: the inner dental epithelium (cylindrical cell decrease with glycogen), stratum intermedium (flattened cells with high metabolism), covered by the stellate reticulum (polygonal cells) and external epithelium (cuboidal cell). At late bell stage epithelial cells become differentiated into odontoblasts and ameloblasts starting to secret both organic, dentin matrix and then enamel matrix.

Material used for cell production and for the next differentiation and/or culture, is preferentially stored at about 35 to 39° C., particularly about 37° C. According to a still more particular embodiment the material is stored in saline balanced solution with antibiotics, mainly streptomycin and/or penicillin. Particularly about 50 units/ml of penicillin and about 50 μg/ml of streptomycin are used.

The material is cut into smaller parts and rinsed with a saline balanced solution added with tissue digestion enzymatic solution for digestion of tissues of tooth bud. According to a particular embodiment of the present invention it is used at least one selected enzyme from the group formed by collagenase or dispase. More particularly, at least one enzyme of each cited group is present. Still in preferential form, collagenase is a type I collagenase, and is present in a concentration ranging from about 5 mg/25 ml to about 20 mg/25 ml. More particularly of about 10 mg/25 ml. And the dispase is a type I dispase, and is present in a concentration ranging from about 3 mg/25 ml to about 15 mg/25 ml. More particularly of about 5 mg/25 ml.

Dissociation of cells is then finished by a mechanical step, as for example a mechanical agitation, during 30 minutes, at a temperature of about 37° C.

After the washing with culture medium and production of cells ready for culture steps, the said cells are placed in appropriate bottles in order to form monolayers for greater area development, more particularly about 20 million cells each square centimeter.

According to the present invention the stage of cell culture (b) can be divided in two phases:
i) An initial period of more than one hour culture, particularly a period of about 48 hours, using a growing medium without bovine serum and/or bovine fetal serum; and
ii) A period of culture with a medium which contains both bovine and/or bovine fetal serum.

More particularly the second phase (ii) may comprises: at least two periods of about 48 hours between which the culture rich medium is changed at least one time; or about four approximately 24 hours periods, between each of them culture rich medium is changed at least one time. Therefore, there is more than one culture medium exchange, and more particularly at least four culture medium exchange.

Said rich culture medium comprises said bovine and/or bovine fetal serum in concentrations of about 5% to 10%. According to another embodiment of the present invention the addition of bovine and/or fetal bovine serum can be gradually increased through each medium exchange, starting on a concentration of about 5% until it achieves a concentration of about 10%.

According to a particular embodiment of the present invention cell culture (b) is about 6 days old. The duration of the culture is particularly advantageous for dental tissue production as development of tooth embryo depends on the reciprocal interaction between epithelial and mesenchymal tissues. In tooth, mesenchymal cells form the dentin, while the epithelial cells form the enamel. Although each mineralized tissue is formed from its respective origin cells, interactions between epithelial-mesenchymal cells are necessary to initiate the mineralization process. In case occurs more mesenchymal development than epithelial, epithelial cells can be strangled by other cells development, resulting on development difficulty for whole dental tissue.

After cultivation, cells are prepared by contact with trypsin and rinsed for impregnation in biodegradable scaffold—stage (c).

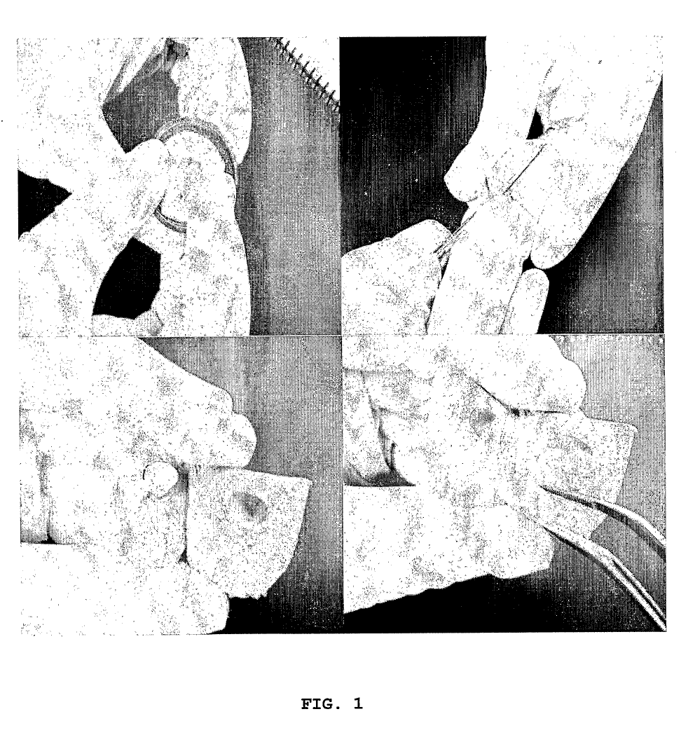

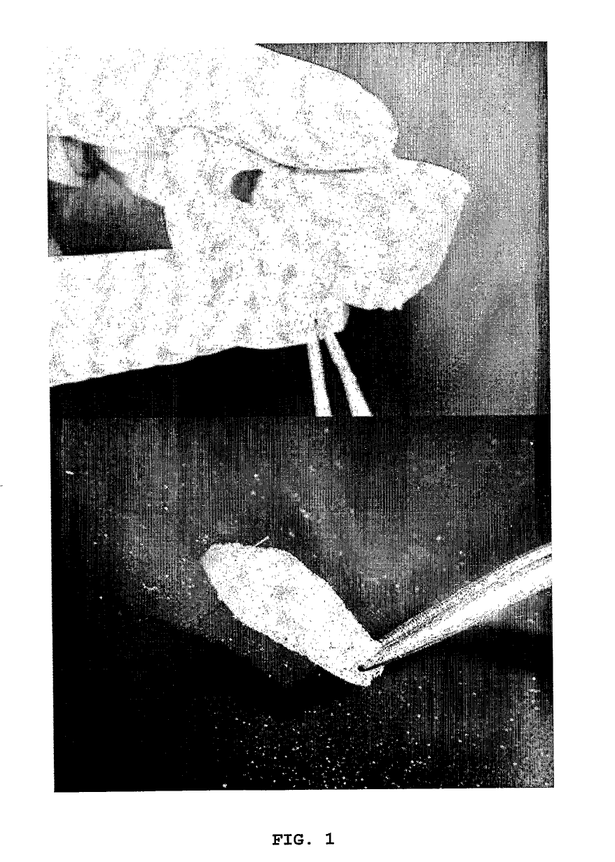

According to a particular embodiment of the present invention scaffold is prior assembled according with the structure to be substituted, meaning incisor, molar or premolar teeth, for example, using silicone molding material (FIGS. 1 and 2).

Material used for scaffold production is particularly a polymeric matrix, more particularly a polymeric matrix derived from α-hydroxiacids as polycaprolate acid (PCL), polyglycolic acid (PGA), co-glycolic polylactic acid (PLGA) and/or poly L-lactic acid (PLLA). Still more particularly polymeric matrix is made of PGA. according to the preferred embodiment of the present invention material used for scaffold formation shows a porosity higher than 95%, meaning pores of about 250˜500 μm.

Scaffold is previously sterilized by techniques known by the state of art, as with ethanol 65%-75%, more particularly 70% concentrate ethanol, or even by ethylene oxide gas or by ionizing radiation. Particularly it is used a technique which does not interfere with the structure or with the physical-chemical-mechanical properties of used material, as ionizing radiation, still more particularly the gamma radiation. Maintenance of scaffold structure will influence cells distribution and its tacky properties to scaffold.

According to a still more particular embodiment of the present invention, the organization of cells impregnated to the scaffold—stage (c)—can be favored when scaffold is previously absorbed in a collagen solution which increases cellular tacking. Particularly, said solution comprises type I and/or type II collagen as a liquid suspension or gel, more particularly at a hydrochloric acid concentration of about 1 mg/ml, approximately 0.1 M. In order to achieve the best result according with the method of the present invention, scaffold so prepared must be impregnated with about approximately 10 to 30, more particularly with about approximately 20 million cells for square centimeters. The amount of cells is particularly advantageous for dental tissues development and the possibility of production of enough amount of needed cells represents the greatest advantage of the present invention in relation to the prior art.

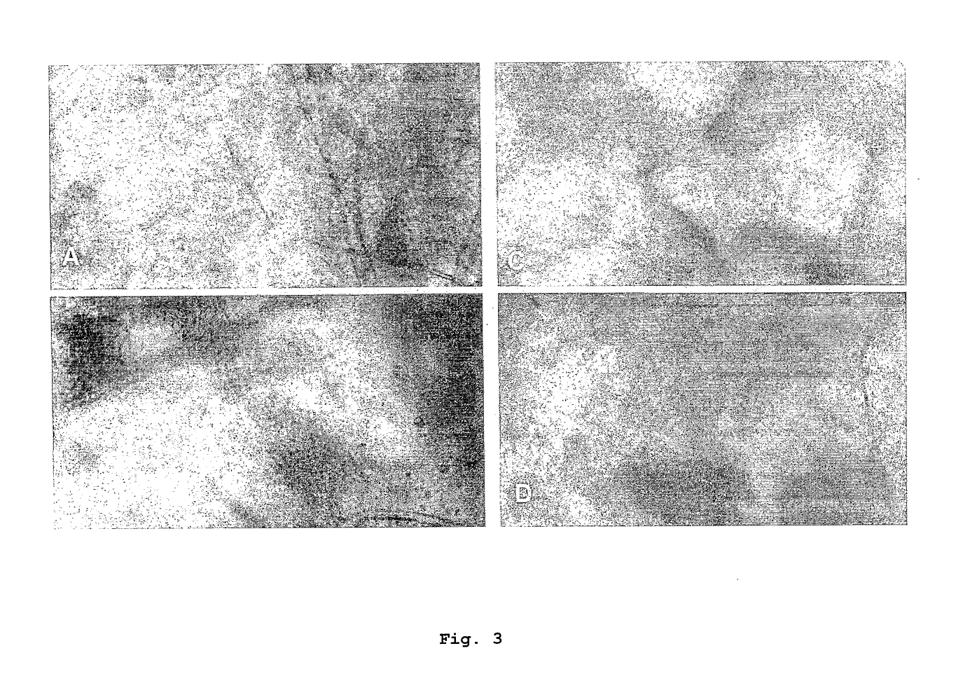

FIG. 3 shows tooth cell organization of impregnated in the scaffold.

After scaffold cell impregnation it should be stored until implantation time. According to the present invention, the assembly scaffold/cells can be stored under dry ice, at approximately 4° C. or room temperature. According to a particular embodiment of the present invention the material is stored at about 37° C.

The next implantation step (d) is preferentially carried within a 24-hour period, more particularly within 12 hours and still more particularly within about 1 hour from cell impregnation.

The implantation itself will be carried through surgical techniques known in the art. According to a particular embodiment of the present invention the assembly scaffold/cells is implanted in the omentum, still more particularly, in the animal jaw.

Changing on implantation site does not represents difficulty for technician both because scaffold can be molded in different desired shapes, and/or because this ability does not involves new techniques, but routinely used ones.

The assembly scaffold/cells is implanted in omentum of syngenic rats in way dental tissue can receive adequate blood nutrition during development. The analysis of dental tissue formed inside the abdomen is made through histological evaluation using both hematoxilin-eosin (H/E) stain method and Goldner's trichrome method. The immunohistochemical analysis is also used with specific antibodies for dental structure with epithelial (keratin, amelogenin) and mesenchymal (osteocalcinin, bone sialoprotein, dentin phosphosialoprotein) markers. These procedure results can establish identification of ameloblasts cells responsible by tooth enamel and odontoblasts cells responsible by dentin formation, as dental structures biologically constructed.

It is still object of the present invention to develop a method for cell cultivation from stem cells comprising:
i) An initial period of more than one hour culture, particularly a period of about 48 hours, using a growing medium without bovine serum and/or bovine fetal serum; and
ii) A period of culture with a medium which contains both bovine and/or bovine fetal serum.

Said process being especially advantageous for cultivation of epithelial cells, mainly along other cells as mesenchymal cells.

The present invention is also related to a dental tissue use for the treatment of people suffering from loss, fails or lacks of these tissues.

It is also a scope of the present invention the cosmetic use of dental tissues for a morphological modifying on a patient dentition. For example, the patient may desire to, or need to, have a bigger or smaller dentition, for any aesthetic reason, not only pathological one.

The present invention is still related to a biological substitute for the tooth produced by the invention method which shows pulp, enamel and dentin.

The following are presented illustrative examples of particular embodiments of the invention, without create any limitations to its scope different from those stated on appended claims.

### EXAMPLE

Lewis Rats had been kept and surgeries had been carried out at “Forsyth Animal Institute Facility”, according to ALAC rules and the National Institute of the Health, protocol IACUC #01-009, and animal insurance #A3051-1.

### Production of the Polymeric Scaffold

Rectangular scaffolds (1×5×5 mm) had been manufactured both from polyglycolic acid (PGA) and copolymer of poly co-glycolic acid (PLGA) as previously described (Young C S, Terada S, Vacanti J P, Honda M, Barlett J D, Yelick PC (2002), “Tissue engineering of complex tooth structure on biodegradable to polymer scaffolds”, J. Dent Res. 81: 695-700). Shortly describing, PGA fiber wicks containing PLLA (aq) 3% w/w had been molded in templates in chloroform, then lyophilized during 48 hours, and sterilized by ionizing radiation. PLGA dental scaffolds were made by filling the half part of PVS molds with NaCl crystals and completing the remaining space with a PLGA molar solution of 85:15 ratio in chloroform 5% w/w, being lyophilized during 48 hours, then washing scaffolds with distilled water for 24 hours, and sterilizing it with ionizing radiation.

### Isolation, Culture and Inoculation of Rats Dental Embryo Cells

Molar dental buds had been isolated through curettage of all developing embryo in new born Lewis rats (3 to 7 days age) and stored at 37° C. in antibiotics associated HBSS solution (50 units/ml of penicillin, 50 μg/ml of streptomycin). The material then is cut into parts smaller than 1 mm³ of size, and then washed with balanced saline Hanks solution (HBSS) (HBSS, Gibco BRL, Gaithersburg, Md., USA) for at least 5 times. Following is added an enzymatic solution for tissues digestion of 10 mg/25 ml of Vibrio aginolyticus type I colagenase (Sigma-Aldrich, St. Louis, Mo., USA) and 5 mg/25 ml of Bacillus polimyxa dispase I (Boehringer Mannheim, Indianapolis, Ind., USA). Then it was placed in incubator at 37° C., with mechanical mixing during 35 minutes. Then tissues were washed 5 times with modified Dulbeco medium (DMEM, Gibco BRL, Gaithersburg, Md., USA), enriched with glutamax 5 ml, penicillin 50 units/ml, streptomycin 50 μg/ml, ascorbic acid 2.5 mg/ml, and F12 medium in a 50:50 ratio (Sigma-Aldrich Corp, St. Louis, Mo., USA).

Suspensions of isolated cells (pellet) were produced by centrifugation in cooled centrifuge with controlled speed of 1500 RPM, during 10 minutes and a temperature of 37° C. After the last washing step cells were filtered through 40 μm nylon sieve and cells are counted in a hemtatometer. Cells are placed in cell culture bottles of 75 square centimeters (T75) (Costar, Cambridge, Mass., USA) in such way that cells amount is diluted in culture medium to promote its growth and expansion, thus its necessary many bottles, as the average amount is at least 1 million of cells for each bottle. During 48 hours, cells are incubated at 37° C. with 95% moisture and 5% of carbonic gas and culture medium is the same as described above. After the 48 hours time, culture medium is removed by pipetting and a new medium is placed in bottles. This new culture medium is constituted of Dulbeco's (DMEM) modified Eagle medium, enriched with bovine fetal serum 10%, glutamax 5 ml, penicillin 50 units/ml, streptomycin 50 μg/ml and ascorbic acid 2.5 mg/ml with F12 in 50:50 ratio. New medium change was carried out through each two following days, with a 6 days culture. Media are removed and bottles washed with balanced phosphate solution (PBS—phosphate buffered saline solution adjusted to pH 7.4, autoclave sterilized—composition of NaCl 8.0 g, KCl 0.2 g, Na₂HPO₄ 1.44 g, KH₂PO₄ 0.24 g, in 900 ml distilled water) and is placed a new culture medium supplemented with bovine fetal serum 10% and kept in incubator. After cellular confluence within approximately 6 days, cultures are incubated with trypsin 0.25% and EDTA 0.05% (ethylene diamine tetraacetic acid) for approximately 15 minutes at 37° C. and then, cells are collected by pippeting, 1500 RPM centrifuged during 10 minutes and keeping the temperature of about 37° C., washed with new culture medium, centrifuged and counted again to be then impregnated (−20 millions cells for square centimeters) in scaffold of PLGA or PGA or PLLA or PCL polymer with prior defined shaped and previously sterilized by gamma radiation sterile conditions, kept previously absorbed with a solution of type I collagen diluted in hydrochloric acid 0.01 M (HCl) previously cooled during at least 12 hours. Before impregnating cells, polymer is washed two times with PBS and with a new culture medium for two times also. This new medium is stored in sterile conditions, under laminar flow, until receiving cells. Then this assembly is kept under room environment or at 37° C. conditions for about 1 hour for cell tacky before the surgical procedure of implantation in omentum of syngenic host Lewis rats.

Immune histochemical analysis of the cytokeratin expression in cultivated epithelial cells of dental embryo had been carried out through the use of a pan-cytokeratin monoclonal antibody, PCK-26 (Sigma-Aldrich, St. Louis, Mo., USA), according with manufacturer recommendation protocol.

### Process of Implantation in the Omentum

Adult Lewis rats (Charles River Laboratories, Wilmington, Mass., USA), with 6 to 12 months age, had been used as hosts for dental tissue implantations. The omentum surgery was carried out through described techniques (Young C S, Terada S, Vacanti J P, Honda M, Barlett J D, Yelick P C (2002). “Tissue engineering of complex tooth structure on biodegradable to polymer scaffolds”. J. Dent Res. 81: 695-700).

### Analysis of Implanted Tissues

X-ray analysis had been carried out through a Hewlett-Packard Faxitron (model 43855 TO-2) equipment and high speed holographic Kodak (aq) film SO-253 at 40 KV and 3 mA during 30 minutes into a focal distance of 40 cm. After visual and x-ray inspections, implantations had been fixed in formalin 5% for 24 hours, decalcified, absorbed in paraffin, cut at intervals of 6μ length and hematoxilin-eosin (H/E) or Goldner stained. Immune histochemical analysis had been carried out through a policlonal amelogenin antibody use as previously described (Young C S, Terada S, Vacanti J P, Honda M, Barlett J D, Yelick P C (2002). “Tissue engineering of complex tooth structure on biodegradable to polymer scaffolds”. J. Dent Res. 81: 695-700). Samples are cut, stained and examined with a Leica DMRE composed microscope and a Zeis Axiocam digital camera (aq).

### Results

Characterization of Cells from Dental Embryo of Cultivated Rats

To determine optimum tooth's embryo age of rats for tissue engineering, populations of cultivated dental cells from dental embryo of 3 to 7 days age rats were prepared. It was carried out at least 3 experiments with a minimum of 6 new born rats (48 molar dental buds) for each development period. After 6 days culture, dental cells seemed to be heterogenic cells, consisting of epithelial similar cells, minor group, and mesenchymal similar cells, fiber cells. In 5, 6 and 7 days cultivation, dental embryo cells had seemed to die within 6 days, showing several unstable cells and low total cell amount. On the other hand, 3 and 4 days dental embryo culture cells had seemed healthful and shown a average number of (2.0×10⁵) and (1.5×10⁵) cells/tooth bud, respectively. Once 4 days dental embryo cells had seemed to proliferate in culture medium while 3 days cells of dental embryo did not, the 4 days molar dental embryo cells of rat were selected for use in all the subsequent experiments of dental tissue engineering.

Immune histological analysis of cytokeratin expression was used to identify epithelial cells in the mix of epithelial and mesenchymal dental cells culture. Positive fluorescent epithelial dental cells cytokeratin had clearly been easily identifiable under UV light, while mesenchyme dental cells had shown only a fluorescence background. Positive control oral epithelium showed immune reactivity of different cytokeratins. 6 days cultivated dental cells had been harvested and impregnated in both the scaffolds of PGA and PLGA for 1 hour at 37° C. in moiety environment, under CO₂ 5%. Scaffolds microscopical light analysis for PGA and PLGA impregnated with cells showed cells adhered to both polymers scaffolds.

### Implantation, Experimental and Control Groups

Groups of control C1-C3 consisting of: (C1) 7 non-dissociated molar dental embryos of 4 days age implanted as positive control; (C2) 5 non-impregnated PGA scaffolds; and (C3) 5 non-impregnated PLGA scaffolds. Experimental groups E1 and E2 consist of: (E1) 8 implantations of PGA scaffold impregnated for 1 hour; e (E2) 8 implantations of PLGA scaffold impregnated for 1 hour. Experimental control implantations had been cultivated in omentum of adult syngenic host rats during 12 weeks, as determined by empirical form of radio-opaque tissue detection in implantations of scaffolds impregnated for dental cells (aq).

### X-Ray Analysis and Appearance of Cut Implantations

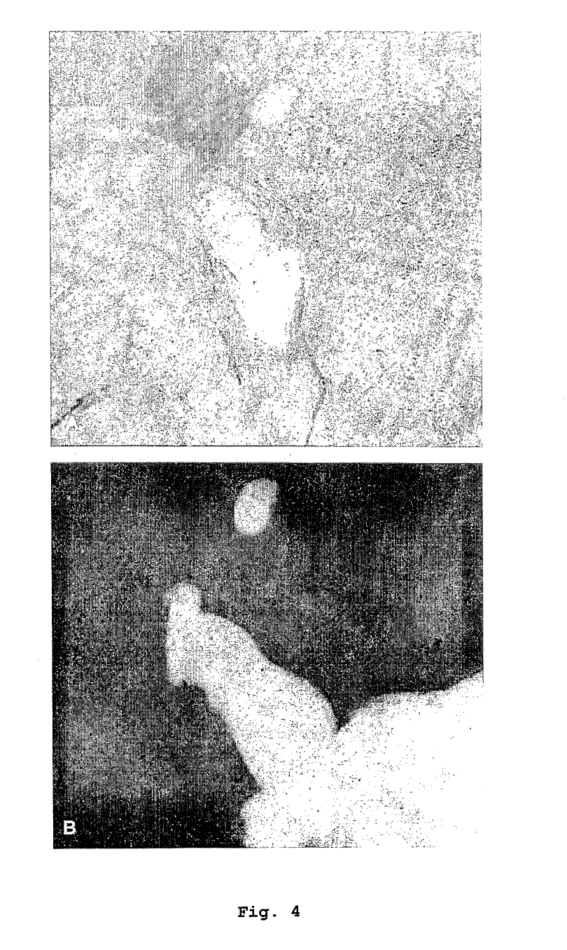

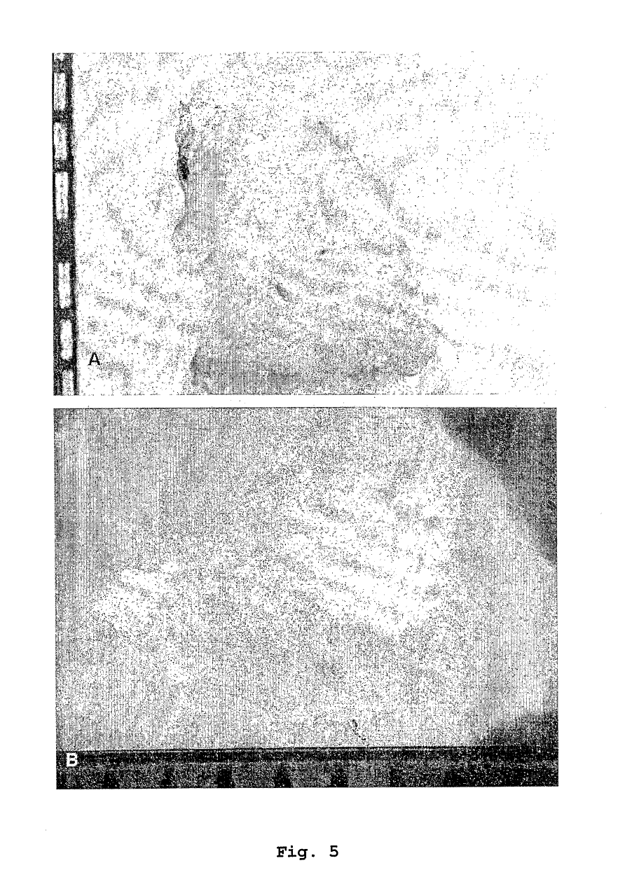

Experimental and control implantations were cut and analyzed in 12 weeks. Implantations had seemed similar in coloration, size and form by visual inspection. Numerous experimental implantations had shown tissue mineralized standing out the implantation. X-ray analysis of experimental implantations had disclosed highly mineralized tissue presence. Negative control, non-impregnated scaffold C2 and C3 groups did not contain any radio-opaque tissue. A total of 7 from 8 (88%) PGA implantations and 4 from 8 (50%) PLGA implantations contained radio-opaque tissue. (FIGS. 4A and 4B and FIGS. 5A and 5B).

### Histological Analysis of 12 Week Implantations

Histological analysis for determination of tissue cellular organization of mineralized implantation were carried out. All C1 control implantations had developed in accurately formed rat molar tooth, being identifiable dentin, enamel and pulp, even when periodontal ligament tissues and cementum have not been whole identifiable in these 12 weeks implantations. Histological analysis of cell impregnated implantations, of PGA and PLGA scaffolds, had showed dentin, enamel and pulp tissues presence. Structures of Hertwig's epithelial root sheath cells were formed in both the types of scaffold material. Permeated lymphocytes had been evidenced in some of implantation cuts.

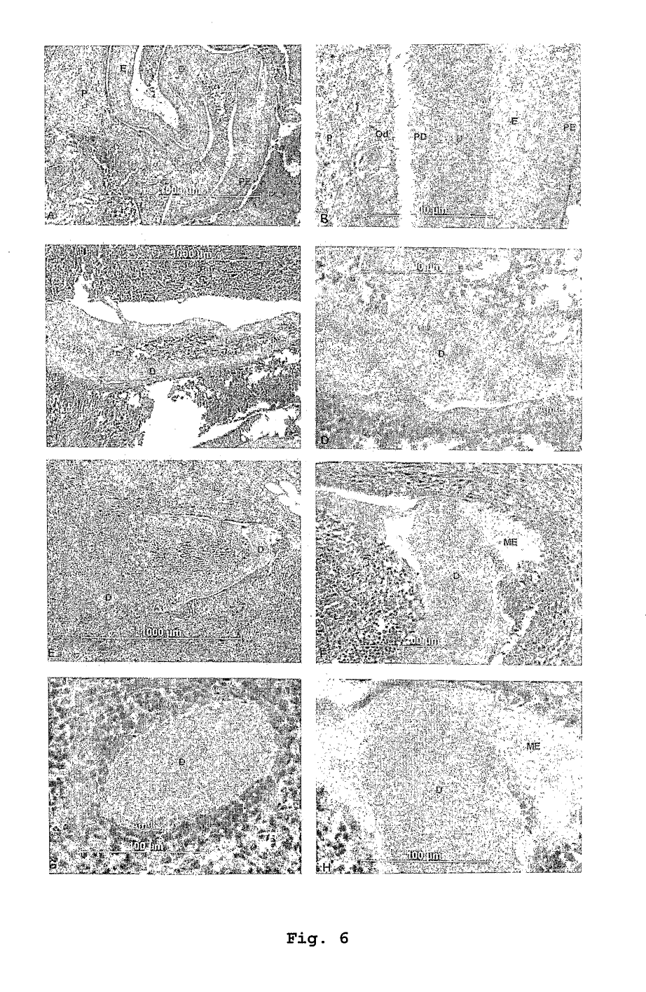

Mineralized tissues of experimental and control implantation groups had been examined through Goldner dye (Bancroft and Gamble, 1999), which stains dentin and bone in blue, new formed enamel matrix in red, and matured enamel in gray. Implantations of unbroken embryo dental control had shown dentin stained in blue, new enamel in red and adult demineralized enamel in gray. By similar form, dental tissue engineered in both PGA and PLGA scaffolds had shown a blue stained dentin and gray mature enamel. Generated dental tissues on PGA scaffolds had generally showed more gray stained mature enamel with Goldner dye, while cells impregnated PLGA scaffolds had generated both immature and mature enamels that stained from reddish to grey (FIG. 6).

### Immune Histochemical Analysis of Dental Tissue Bioengineering Created of Rats

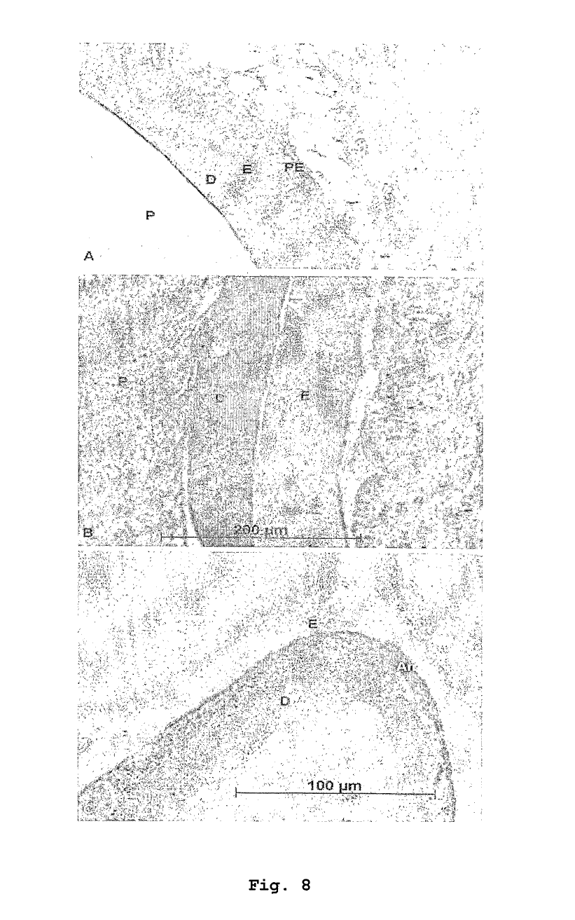

Immune histochemical analysis had been used to examine the expression of amelogenin in bioengineering generated enamel. Control implantations of unbroken dental embryo had showed positive expression of amelogenin in ameloblasts and demineralized enamel, while pre-immune control tissues were negative. Bioengineering cultivated enamel in both PGA and PLGA scaffolds had showed positive stain for amelogenin (FIG. 8).

As understood by any technician regarding herein subject, there are numerous possible modifications and variations of the present invention based on the teachings disclosed above, without become away from the scope of the present invention, as limited by the appended claims.

1. Use of stem cells of an animal species which is for obtainment of a biological tooth substitute, in whole or in parts, to be implanted into an organism of the same animal strain.

2. Use, according to claim 1, wherein the said stem cells are embryo or adult cells.

3. Use, according to claim 2, wherein the said stem cells are adult cells.

4. Method of tissue engineering for cell culture capable to form tissue dental for biological tooth substitute production comprising:
a) obtaining cells capable to form dental tissue from stem cells;
b) culturing cells from (a), wherein the cells are initially cultivated in the absence of bovine serum and/or bovine fetal serum;
c) seeding cultivated cells in a biodegradable material scaffold; and
d) implanting the scaffold assembly into organism of the same animal strain which cells are capable to form dental tissue, from which the original dental cells came from.

5. Method, according to claim 4, wherein the said stem cells are embryonic or adult cells.

6. Method, according to claim 4, wherein the said stem cells are adult cells.

7. Method, according to claim 6, wherein the said stem cells are extracted adult cells from tooth embryo, preferentially of tooth in button formation stage.

8. Method, according to claim 4, wherein the material used for cells production in the step (a) and for next differentiation and/or cultivation is preferentially stored in a temperature from about 35 to about 39° C., particularly about 37° C.

9. Method, according to claim 4, wherein the material used for the production of cells in step (a) is stored in balanced saline solution with antibiotic.

10. Method, according to claim 9, wherein the antibiotic is streptomycin and/or penicillin, used preferential at about 50 units/ml of penicillin and about 50 μg/ml of streptomycin.

11. Method, according to claim 4, wherein the said material used for cells production in the step (a) is digested by the addition of an enzymatic solution, where the said solution comprises at least one enzyme selected of the group of collagenase or dispase.

12. Method, according to claim 11, wherein colagenase is preferential a type I collagenase, and is present in a concentration ranging from about 5 mg/25 ml to about 20 mg/25 ml. More particularly of about 10 mg/25 ml. And the dispase is a type I dispase, and is present in a concentration ranging from about 3 mg/25 ml to about 15 mg/25 ml. More particularly of about 5 mg/25 ml.

13. Method, according to claim 11, wherein the said digestion is finished by mechanical action, being the material kept on a temperature of about 37° C.

14. Method, according to claim 4, wherein the stage of cell culture be divided in two phases:
i) an initial period of more than one hour culture, particularly a period of about 48 hours, using a growing medium without bovine serum and/or bovine fetal serum; and
ii) a period of culture with a medium which contains both bovine and/or bovine fetal serum.

15. Method, according to claim 14, wherein the second phase comprises: at least two periods of about 48 hours between which the culture rich medium is changed at least one time; or about four approximately 24 hours periods, between each of them culture rich medium is changed at least one time, particularly at least four culture medium exchange.

16. Method, according to claim 14 or 15, wherein said bovine and/or bovine fetal serum is present in a concentration of about 5% to 10%.

17. Method, according to claim 14 or 15, wherein the addition of bovine serum and/or fetal bovine serum is gradually increased through each medium exchange, starting on a concentration of about 5% until it achieves a concentration of about 10%.

18. Method, according to claim 4, wherein the said cellular culture is 6 days old.

19. Method, according to claim 4, wherein said scaffold is prior molded from a polymeric matrix.

20. Method, according to claim 19, wherein the polymeric matrix is derived from polymers particularly derived from α-hydroxyl polycaprolate acid (PCL), polyglycolic acid (PGA), polylactic co-glycolic acid (PLGA) and/or poly L-lactic acid (PLLA).

21. Method, according to claim 20, wherein said polymeric matrix is derived from PGA.

22. Method, according to claim 19, wherein the said matrix shows a porosity higher 95%, particularly pores of about 250˜500 μm.

23. Method, according to claim 4, wherein said scaffold is sterilized by ethanol 65%-75%, more particularly 70%, ethylene oxide gas or ionizing radiation.

24. Method, according to claim 23, wherein said scaffold is sterilized by ionizing radiation, particularly gamma radiation.

25. Method, according to claim 4, wherein said scaffold is prior absorbed in collagen solution.

26. Method, according to claim 25, wherein the said collagen solution comprises type I and/or II collagen in the form of liquid suspension or gel, more particularly at a hydrochloric acid concentration of about 1 mg/ml, approximately 0.1 M.

27. Method, according to claim 4, wherein said scaffold is impregnated with about approximately 10-30, particularly about approximately 20 million cells by square centimeter.

28. Method, according to claim 4, wherein the said stage of implantation is preferentially carried within a 24-hours period, more particularly within 12 hours and still more particularly within about 1 hour from cell impregnation.

29. Method, according to claim 28, wherein scaffold impregnated is stored until implantation time under dry ice, at approximately 4° C. or at room temperature.

30. Method, according to claim 29, wherein impregnated scaffold is stored until the moment of the implantation at a temperature of about 37° C.

31. Method, according to claim 4, wherein the said implantation is carried out in the omentum or in the animal jaw.

32. Method, according to claim 31, wherein the implantation is carried out in the animal jaw.

33. Use of dental tissue obtained according to method defined in claim 4, wherein it is for the treatment of people who suffer from loss, fail or lack of these tissues.

34. Cosmetic use of dental tissue produced according to method defined in claim 4, wherein it is for morphologically modify the patient dentition.

35. Method for stem cell culture, wherein comprises:
i) an initial period of more than one hour culture, particularly a period of about 48 hours, using a growing medium without bovine serum and/or bovine fetal serum; and
ii) a period of culture with a medium which contains both bovine and/or bovine fetal serum.

36. Tooth biological substitute produced according to method defined in claim 4, wherein is presenting enamel, dentin and pulp.
